(19) United States
(12) Patent Application Publication
(10) Pub. No.: US 2014/0377520 A1
(43) Pub. Date: Dec. 25, 2014

(54) WINDOW FOR DISPLAY DEVICE AND DISPLAY DEVICE INCLUDING THE WINDOW PANEL

(71) Applicant: Samsung Display Co., Ltd., Yongin-City (KR)

(72) Inventor: Se-In CHANG, Yongin-City (KR)

(73) Assignee: Samsung Display Co., Ltd., Yongin-City (KR)

(21) Appl. No.: 14/158,428

(22) Filed: Jan. 17, 2014

(30) Foreign Application Priority Data
Jun. 21, 2013 (KR) 10-2013-0071851

(51) Int. Cl. B32B 27/08

(52) U.S. Cl. CPC B32B 27/08
USPC 428/213; 428/480; 428/448; 428/335; 428/337; 428/220

(57) ABSTRACT

Disclosed are a window for a display device including a window mother substrate for the display device; and a protective film disposed on the window mother substrate for the display device, wherein the protective film includes a multi-layer structure disposed on the window mother substrate for the display device, a first plastic substrate disposed on the multi-layer structure, and a second plastic substrate disposed on the first plastic substrate, and a display device including the same.

### RELATED APPLICATIONS

This application claims priority to and the benefit of Korean Patent Application No. 10-2013-0071851 filed in the Korean Intellectual Property Office on Jun. 21, 2013, the entire contents of which are incorporated herein by reference.

### BACKGROUND

1. Field

A window for a display device and a display device including the same are disclosed.

2. Description of the Related Art

Currently known display devices include liquid crystal displays (LCD), plasma display panels (PDP), organic light emitting diode displays (OLED), field effect displays (FED), electrophoretic display devices, and the like.

Such display devices include a display module displaying an image and a window that protects the display module.

This window may be attached with a film instead of a printing method so that a special pattern may be incorporated into the window. When an ink layer printed on the film is externally exposed, however, the ink layer may be weakened due to moisture vapors from the external atmosphere that permeate the ink layer.

### SUMMARY

A window for a display device is provided that has improved reliability by preventing moisture invasion.

A display device including the window is also provided.

According to an aspect, a window for a display device includes a window mother substrate for the display device; and a protective film disposed on the window mother substrate for the display device, wherein the protective film includes a multi-layer structure disposed on the window mother substrate for the display device, a first plastic substrate disposed on the multi-layer, and a second plastic substrate disposed on the first plastic substrate.

The first plastic substrate may include an ultraviolet (UV) curable resin.

The first plastic substrate may further include a pigment.

The second plastic substrate may include a light transmittance polymer resin.

The second plastic substrate may include polyethylene terephthalate (PET).

The multi-layer structure may include a silicon oxide layer and a titanium oxide layer that are alternately deposited.

The multi-layer structure may include a structure of three stacked layers.

An ink layer may be further included between the first plastic substrate and the second plastic substrate.

An adhesive layer may be further included between the window mother substrate for the display device and the protective film.

The protective film may have an about 10% to about 30% thickness relative to the total thickness of the window.

The first plastic substrate may have a thickness of about 2 μm to about 50 μm.

The second plastic substrate may have a thickness of about 30 μm to about 300 μm.

The window mother substrate may include a polymer resin layer and a light transmittance film disposed on the polymer resin layer.

The light transmittance film may include a plastic substrate selected from a polyethylene terephthalate (PET) film, a polycarbonate (PC) film, a polymethylmethacrylate (PMMA) film, a polycarbonate/polymethylmethacrylate (PC/PMMA) film, or a combination thereof.

The light transmittance film may further include a binder layer disposed between the polymer resin layer and the plastic substrate.

The light transmittance film may further include a hard coating layer disposed on one side of the plastic substrate.

The window for a display device may have a thickness of less than or equal to about 2 mm.

According to another aspect, a display device including the window for the display device is provided.

Moisture is prevented from invading into the window for the display device, and thus reliability of the device may be improved.

### BRIEF DESCRIPTION OF THE DRAWINGS

FIG. 1 is a cross-sectional view of a window for a display device according to an example embodiment.

FIG. 2 is a cross-sectional view of a window for a display device included in the display device according to an example embodiment.

### DETAILED DESCRIPTION

Hereinafter, example embodiments will be described in detail so that a person skilled in the relevant art would understand. This disclosure may, however, be embodied in many different forms and is not to be construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element, or intervening elements may also be present. In contrast, when an element is referred to as being “directly on” another element, there are no intervening elements present.

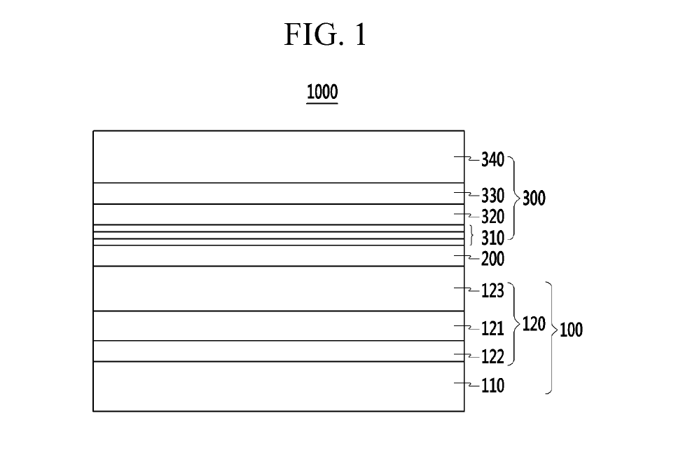

Referring to FIG. 1, a window for a display device according to an example embodiment will be described.

FIG. 1 is a cross-sectional view of a window for a display device according to an example embodiment.

A window 1000 for a display device according to an example embodiment includes a window mother substrate 100 for the display device and a protective film 300 disposed on the window mother substrate 100 for the display device.

The window mother substrate 100 for the display device is a layer that protects a display module and will be described below.

The protective film 300 is a layer protecting the window mother substrate 100, and as a result protects the display module. The protective film 300 includes a multi-layer structure 310, a first plastic substrate 320 positioned on the multi-layer structure 310, and a second plastic substrate 340 positioned on the first plastic substrate 320.

The multi-layer structure 310 is positioned on the window mother substrate 100 for the display device and is a barrier that prevents moisture and oxygen from the exterior of the display device to permeate into the display device.

The multi-layer structure 310 may be, for example, made of an inorganic material. The inorganic material may be oxide, nitride or oxynitride of a semi-metal or a metal. For example, the inorganic material may include oxide, nitride or oxynitride of silicon (Si), or oxide, nitride or oxynitride of titanium (Ti).

The multi-layer structure 310 has a structure that includes two or more stacked layers, for example, a structure of three stacked layers, but is not limited thereto. The three stacked layers may be, for example a silicon oxide layer, a titanium oxide layer, and a silicon oxide layer stacked in sequence, or a titanium oxide layer, a silicon oxide layer, and a titanium oxide layer stacked in sequence.

The first plastic substrate 320 is positioned on the multi-layer structure 310. The first plastic substrate 320 may be pressed with a presser for forming protrusions and depressions. Accordingly, the first plastic substrate 320 may have protrusions and depressions. The first plastic substrated 320 is formed on the multi-layer structure 310. The protrusions and depressions of the first plastic substrate 320 may therefore be transferred into the multi-layer structure 310 through the first plastic substrate 320.

The first plastic substrate 320 may include an ultraviolet (UV) curable resin. The ultraviolet (UV) curable resin is not limited to a particular resin, and may be, for example, an acryl-based compound, an epoxy-based compound, or a combination thereof.

The first plastic substrate 320 may further include a photopolymerization initiator along with the ultraviolet (UV) curable resin. The photopolymerization initiator may include, for example, an acetophenone-based compound or a benzophenone-based compound, but is not limited thereto.

The first plastic substrate 320 may further include a pigment. Herein, the first plastic substrate 320 may be a color layer that imparts a color to the protective film 300. The pigment may be an organic or an inorganic pigment that is black, blue, or colorless, and the like, but is not limited thereto.

The second plastic substrate 340 is positioned on the first plastic substrate 320. The second plastic substrate 340 may include a light transmittance polymer resin. The light transmittance polymer resin may be any resin having light transmittance without limitation, and may be, for example, polyethylene terephthalate (PET), polycarbonate (PC), polymethylmethacrylate (PMMA), and the like. The second plastic substrate 340 may include, for example polyethylene terephthalate (PET).

Because of the second plastic substrate 340, the first plastic substrate 320 is not positioned on the utmost surface of the protective film 300, but is on the interior of the second plastic substrate 340. A material included in the second plastic substrate 340, for example, polyethylene terephthalate (PET), has lower vapor permeability than a pigment included in the first plastic substrate 320. Therefore, the structure in which the first plastic substrate 320 is positioned on the interior with respect to the second plastic substrate 340 may decrease vapor permeability of the protective film 300 and minimize defects due to water vapors.

The window 1000 for a display device may further include an ink layer 330 positioned between the first plastic substrate 320 and the second plastic substrate 340. The ink layer 330 imparts a color to the protective film 300, or it may be omitted.

The ink layer 330 may be positioned not the outer surface but on the interior of protective film 300. In other words, the ink layer 330 may be positioned on the interior with respect to the second plastic substrate 340, or may be omitted. A material included in the second plastic substrate 340, for example, polyethylene terephthalate (PET), has lower vapor permeability than that of an ink included in the ink layer 330. Therefore, the structure in which the ink layer 330 is positioned on the interior with respect to the second plastic substrate 340, or omitted, may decrease the vapor permeability of the protective film 300 and minimize defects due to water vapors.

The window 1000 for a display device may further include an adhesive layer 200 interposed between the window mother substrate 100 and protective film 300. The adhesive layer 200 is positioned between the window mother substrate 100 and the protective film 300 and bonds the window mother substrate 100 to the protective film 300. The adhesive layer 200 may include a transparent polymer resin, and the transparent polymer resin may be, for example OCA (Optically Clear Adhesive), SVR (Super View Resin), PSA (pressure sensitive adhesive) or a combination thereof, but is not limited thereof.

The window 1000 for a display device may have a thickness of about 2 μm to about 50 μm. The protective film 300 may have an about 10% to about 30% thickness, and specifically an about 10% to about 20% thickness relative to a total thickness of the window 1000 for a display device.

The multi-layer structure 310 may have, for example a thickness of about 0.01 μm to 10 μm, the first plastic substrate 320 may have, for example a thickness of about 2 μm to about 50 μm, and the second plastic substrate 340 may have, for example a thickness of about 30 μm to about 300 μm.

Hereinafter, the window mother substrate 100 for a display device is described referring to FIG. 1.

Referring to FIG. 1, the window mother substrate 100 includes a polymer resin layer 110 and a light transmittance film 120 positioned on one side of the polymer resin layer 110.

The polymer resin layer 110 may be made of an injection moldable polymer resin, for example polycarbonate (PC), a polycarbonate-polymethylmethacrylate (PC-PMMA) blend, a cycloolefin polymer (COP), a copolymer thereof, or a combination thereof. Herein, the ‘combination’ of the resins may refer to a blend of two or more resins or a stack of two or more layers of the resins.

The light transmittance film 120 includes a plastic substrate 121, a binder layer 122, and a hard coating layer 123.

The plastic substrate 121 is used for a film insert forming process, and may be, for example, a polyethyleneterephthalate (PET) film, a polycarbonate (PC) film, a polymethylmethacrylate (PMMA) film, a polycarbonate/polymethylmethacrylate (PC/PMMA) film, or a combination thereof. The plastic substrate 121 may have a thickness, for example, of about 50 μm to about 100 μm.

The binder layer 122 is interposed between the polymer resin layer 110 and the plastic substrate 121, and bonds the two layers. The binder layer may include, for example an acryl-based binder. The binder layer 122 may have a thickness, for example, of about 5 μm to about 10 μm.

The hard coating layer 123 is positioned on the surface of the window 1000 for a display device and furthermore improves surface hardness. The hard coating layer 123 may include, for example an organic material, an inorganic material, or an organic/inorganic composite compound. Herein the organic material may include, for example an acryl-based compound, an epoxy-based compound, or a combination thereof, the inorganic material may include, for example silica, alumina, or a combination thereof, and the organic/inorganic composite compound may include, for example polysilsesquioxane. The hard coating layer 123 may be a monolayer or a plural layer, and may have a thickness, for example of about 50 μm to about 150 μm.

At least one of the binder layer 122 and hard coating layer 123 may be omitted as needed.

The light transmittance film 120 may be, for example an IMD film (In mold decoration film).

The light transmittance film 120 is formed on one side of the polymer resin layer 110 but is not limited thereto, and may be formed on both sides of the polymer resin layer 110.

The window mother substrate 100 for a display device may be obtained by injection-molding the light transmittance film 120 and the polymer resin in a film insert manner.

A window for a display device according to an example embodiment may minimize vapor permeation due to an ink layer on utmost top by omitting the ink layer in a protective film and using a first plastic substrate as a color layer. Simultaneously, the device may be manufactured to be thin by simplifying the stacking structure.

The above described window for a display device may be used with various display devices. The display device may be a liquid crystal display (LCD), an organic light emitting diode (OLED) display, a plasma display, an electric field effect display device, an electrophoresis display device, and the like, but is not limited thereto.

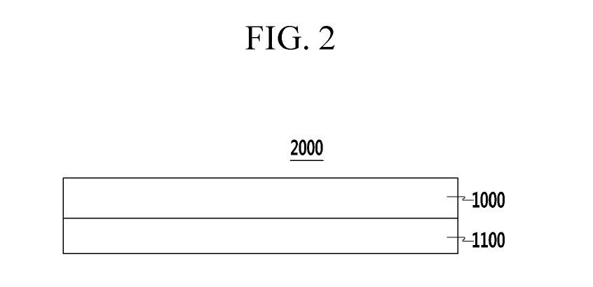

FIG. 2 is a cross-sectional view of a display device according to an example embodiment.

Referring to FIG. 2, the display device 2000 includes a display module 1100 and the window 1000 disposed on the window module 1100.

While this disclosure has been described in connection with what is presently considered to be practical example embodiments, it is to be understood that the invention is not limited to the disclosed embodiments, but, on the contrary, is intended to cover various modifications and equivalent arrangements included within the spirit and scope of the disclosure, including the appended claims.

### DESCRIPTION OF SYMBOLS

1000: window for a display device

1100: display module

2000: display device

100: window mother substrate for a display device

200: adhesive layer

300: protective film

310: multi-layer structure

320: first plastic substrate

330: ink layer

340: second plastic substrate

110: polymer resin layer

120: light transmittance film

121: plastic film

122: binder layer

123: hard coating layer

What is claimed is:

1. A window for a display device, comprising
a window mother substrate for the display device; and
a protective film disposed on the window mother substrate for the display device,
wherein the protective film includes a multi-layer structure disposed on the window mother substrate for the display device, a first plastic substrate disposed on the multi-layer structure, and a second plastic substrate disposed on the first plastic substrate.

2. The window for a display device of claim 1, wherein the first plastic substrate comprises an ultraviolet (UV) curable resin.

3. The window for a display device of claim 2, wherein the first plastic substrate further comprises a pigment.

4. The window for a display device of claim 1, wherein the second plastic substrate comprises a light transmittance polymer resin.

5. The window for a display device of claim 4, wherein the second plastic substrate comprises polyethylene terephthalate (PET).

6. The window for a display device of claim 1, wherein the multi-layer structure comprises a silicon oxide layer and a titanium oxide layer that are alternately deposited.

7. The window for a display device of claim 1, wherein the multi-layer structure comprises a structure of three stacked layers.

8. The window for a display device of claim 1, wherein an ink layer is further included between the first plastic substrate and the second plastic substrate.

9. The window for a display device of claim 1, wherein an adhesive layer is further included between the window mother substrate for the display device and the protective film.

10. The window for a display device of claim 1, wherein the protective film has an about 10% to about 30% thickness relative to a total thickness of the window.

11. The window for a display device of claim 1, wherein the first plastic substrate has a thickness of about 2 μm to about 50 μm.

12. The window for a display device of claim 1, wherein the second plastic substrate has a thickness of about 30 μm to about 300 μm.

13. The window for a display device of claim 1, wherein the window mother substrate comprises a polymer resin layer and a light transmittance film disposed on the polymer resin layer.

14. The window for a display device of claim 13, wherein the light transmittance film comprises a plastic substrate selected from a polyethylene terephthalate (PET) film, a polycarbonate (PC) film, a polymethylmethacrylate (PMMA) film, a polycarbonate/polymethylmethacrylate (PC/PMMA) film, or a combination thereof.

15. The window for a display device of claim 14, wherein the light transmittance film further comprises a binder layer positioned between the polymer resin layer and the plastic substrate.

16. The window for a display device of claim 14, wherein the light transmittance film further comprises a hard coating layer disposed on one side of the plastic substrate.

17. The window for a display device of claim 1, wherein the window for a display device has a thickness of less than or equal to about 2 mm.

18. A display device comprising the window for the display device according to claim 1.
